(19) United States
(12) Patent Application Publication
(10) Pub. No.: US 2015/0073962 A1
(43) Pub. Date: Mar. 12, 2015

(54) Boundary Constraint-Based Settlement in Spread Markets

(71) Applicant: Chicago Mercantile Exchange Inc., Chicago, IL (US)

(72) Inventors: David Bixby, Arlington Heights, IL (US); Alex Behrens, Roselle, IL (US)

(73) Assignee: Chicago Mercantile Exchange Inc., Chicago, IL (US)

(21) Appl. No.: 14/022,911

(22) Filed: Sep. 10, 2013

(51) Int. Cl. G06Q 40/04

(52) U.S. Cl. CPC G06Q 40/04
USPC 705/37

(57) ABSTRACT

A computer implemented method determines a settlement price for a constituent contract of a plurality of spread instruments. The method includes obtaining market data indicative of bid-offer values for the plurality of spread instruments, generating synthetic market data for the constituent contract based on the bid-offer values and based on a respective settlement price for an active contract of each spread instrument of the plurality of spread instruments, determining boundary constraints on the settlement price for the constituent contract based on the synthetic market data, and computing the settlement price for the constituent contract based on the boundary constraints.

### TECHNICAL FIELD

The following disclosure relates to software, systems and methods for determining margin requirements in a commodities exchange, derivatives exchange or similar business.

### BACKGROUND

A financial instrument trading system, such as a futures exchange, referred to herein also as an “Exchange”, such as the Chicago Mercantile Exchange Inc. (CME), provides a contract market where financial instruments, for example futures and options on futures, are traded. Futures is a term used to designate all contracts for the purchase or sale of financial instruments or physical commodities for future delivery or cash settlement on a commodity futures exchange. A futures contract is a legally binding agreement to buy or sell a commodity, such as a grain commodity, at a specified price at a predetermined future time. An option is the right, but not the obligation, to sell or buy the underlying instrument (in this case, a futures contract) at a specified price within a specified time. The commodity to be delivered in fulfillment of the contract, or alternatively the commodity for which the cash market price shall determine the final settlement price of the futures contract, is known as the contract's underlying reference or “underlier.” The terms and conditions of each futures contract are standardized as to the specification of the contract's underlying reference commodity, the quality of such commodity, quantity, delivery date, and means of contract settlement. Cash Settlement is a method of settling a futures contract whereby the parties effect final settlement when the contract expires by paying/receiving the loss/gain related to the contract in cash, rather than by effecting physical sale and purchase of the underlying reference commodity at a price determined by the futures contract, price. Options and futures may be based on more abstract market indicators, such as stock indices, interest rates, futures contracts and other derivatives.

A spread instrument involves the simultaneous purchase of one security and sale of a related security, called legs, as a unit. The legs of a spread instrument are usually options or futures contracts, but other securities are sometimes used. Trades in spread instruments are executed to yield an overall net position whose value, called the spread, depends on the difference between the prices of the legs. Spread instruments are traded in an attempt to profit from the widening or narrowing of the spread, rather than from movement in the prices of the legs directly. Spread instruments are either “bought” or “sold” depending on whether the trade will profit from the widening or narrowing of the spread, respectively. An Exchange often supports trading of common spreads as a unit rather than as individual legs, thus ensuring simultaneous execution and eliminating the execution risk of one leg executing but the other failing.

One example of a spread instrument is a calendar spread instrument. The legs of a calendar spread instrument differ in delivery date of the underlier. The leg with the earliest occurring delivery date is often referred to as the lead month contract. A leg with a later occurring delivery date is often referred to as a deferred month contract.

Typically, the Exchange provides for a centralized “clearing house” through which all trades made must be confirmed, matched, and settled each day until offset or delivered. The clearing house is an adjunct to the Exchange, and may be an operating division of the Exchange, which is responsible for settling trading accounts, clearing trades, collecting and maintaining performance bond funds, regulating delivery, and reporting trading data. The essential role of the clearing house is to mitigate credit risk. Clearing is the procedure through which the Clearing House becomes buyer to each seller of a futures contract, and seller to each buyer, also referred to as a novation, and assumes responsibility for protecting buyers and sellers from financial loss due to breach of contract, by assuring performance on each contract. A clearing member is a firm qualified to clear trades through the Clearing House.

The Clearing House of an Exchange clears, settles and guarantees all matched transactions in contracts occurring through the facilities of the Exchange. In addition, the Clearing House establishes and monitors financial requirements for clearing members and conveys certain clearing privileges in conjunction with the relevant exchange markets.

The Clearing House establishes clearing level performance bonds (margins) for all products of the Exchange and establishes minimum performance bond requirements for customers of such products. A performance bond, also referred to as a margin requirement, corresponds with the funds that must be deposited by a customer with his or her broker, by a broker with a clearing member or by a clearing member with the Clearing House, for the purpose of insuring the broker or Clearing House against loss on open futures or options contracts. This is not a part payment on a purchase. The performance bond helps to ensure the financial integrity of brokers, clearing members and the Exchange as a whole. The Performance Bond to Clearing House refers to the minimum dollar deposit, which is required by the Clearing House from clearing members in accordance with their positions. Maintenance, or maintenance margin, refers to a sum, usually smaller than the initial performance bond, which must remain on deposit in the customer's account for any position at all times. The initial margin is the total amount of margin per contract required by the broker when a futures position is opened. A drop in funds below this level requires a deposit back to the initial margin levels, i.e. a performance bond call. If a customer's equity in any futures position drops to or under the maintenance level because of adverse price action, the broker must issue a performance bond/margin call to restore the customer's equity. A performance bond call, also referred to as a margin call, is a demand for additional funds to bring the customer's account back up to the initial performance bond level whenever adverse price movements cause the account to go below the maintenance.

The Exchange derives its financial stability in large part by removing debt obligations among market participants as they occur. This is accomplished by determining a settlement price at the close of the market each day for each contract and marking all open positions to that price, referred to as “mark to market.” Every contract is debited or credited based on that trading session's gains or losses. As prices move for or against a position, funds flow into and out of the trading account. In the case of the CME, each business day by 6:40 a.m. Chicago time, based on the mark-to-the-market of all open positions to the previous trading day's settlement price, the Clearing House pays to or collects cash from each clearing member. This cash flow, known as settlement variation, is performed by CME's settlement banks based on instructions issued by the Clearing House. All payments to and collections from clearing members are made in “same-day” funds. In addition to the 6:40 a.m. settlement, a daily intra-day mark-to-the market of all open positions, including trades executed during the overnight GLOBEX®, the CME's electronic trading systems, trading session and the current day's trades matched before 11:15 a.m., is performed using current prices. The resulting cash payments are made intra-day for same day value. In times of extreme price volatility, the Clearing House has the authority to perform additional intra-day mark-to-the-market calculations on open positions and to call for immediate payment of settlement variation. Settlement variation payments through the Clearing House average $1.4 billion per day and have reached a peak of $6.4 billion. CME's mark-to-the-market settlement system stands in direct contrast to the settlement systems implemented by many other financial markets, including the interbank, Treasury securities, over-the-counter foreign exchange and debt, options, and equities markets, where participants regularly assume credit exposure to each other. In those markets, the failure of one participant can have a ripple effect on the solvency of the other participants. Conversely, CME's mark-to-the-market system does not allow losses to accumulate over time or allow a market participant the opportunity to defer losses associated with market positions.

In order to minimize risk to the Exchange while minimizing the burden on members, it is desirable to approximate the requisite performance bond or margin requirement as closely as possible to the actual positions of the account at any given time. With some spread instruments, the market is sufficiently inactive during or at the end of the trading day. Very little, if any, trades may occur during a given day. In such cases, it may be difficult to determine daily settlement prices for purposes of accurately estimating performance bond requirements.

### BRIEF DESCRIPTION OF THE DRAWINGS

FIG. 1 depicts a block diagram of an exemplary system for trading futures contracts, spread instruments, and/or other financial products according to the disclosed embodiments.

FIG. 2 is a block diagram of an exemplary system for determining a settlement price for a deferred month or other constituent contract of a set of spread instruments in accordance with one embodiment.

FIG. 3 is a flow chart diagram of an exemplary method for determining a settlement price for a deferred month or other constituent contract of a set of spread instruments in accordance with one embodiment.

FIG. 4 shows an illustrative embodiment of a general computer system for use with the system of FIG. 1 and/or the system of FIG. 2 and/or for implementing the method of FIG. 3.

FIG. 5A is a table of exemplary trade and market data for a set of spread instruments to present an example of a prior art procedure for determining a deferred month settlement price in which a resulting spread instrument value falls outside of a bid-offer range.

FIG. 5B is a table of exemplary trade and market data for a set of spread instruments to present an example of a boundary constraint-based procedure for determining a deferred month contract settlement price in accordance with one embodiment.

FIGS. 6A and 6B are tables of exemplary trade and market data for a set of spread instruments to present an example of a boundary constraint adjustment of the boundary constraint-based procedure in accordance with one embodiment.

### DETAILED DESCRIPTION

The disclosed embodiments relate to determining settlement prices for constituent contracts of spread instruments. Synthetic market data is generated for a constituent contract of a set of spread instruments. The synthetic market data is generated based on market data indicative of bid-offer values (i.e., bid-ask values) for the set of spread instruments. The synthetic market data is used to determine boundary constraints on the settlement price for the constituent contract. The best (i.e., highest) bid in the synthetic market corresponds with a lower boundary constraint for (or bound on) the settlement price, while the best (i.e., lowest) offer in the synthetic market corresponds with an upper boundary constraint. The settlement price for the constituent contract may then be determined by computing an average or midpoint of the lower and upper boundary constraints.

The synthetic market data may include a set of synthetic bids and a set of synthetic offers for the constituent contract. Each set contains a bid (or offer) determined in accordance with a respective one of the set of spread instruments. In some cases, the sets of synthetic bids and offers may include market data indicative of bids and offers from the market for the constituent contract itself, i.e., the outright market.

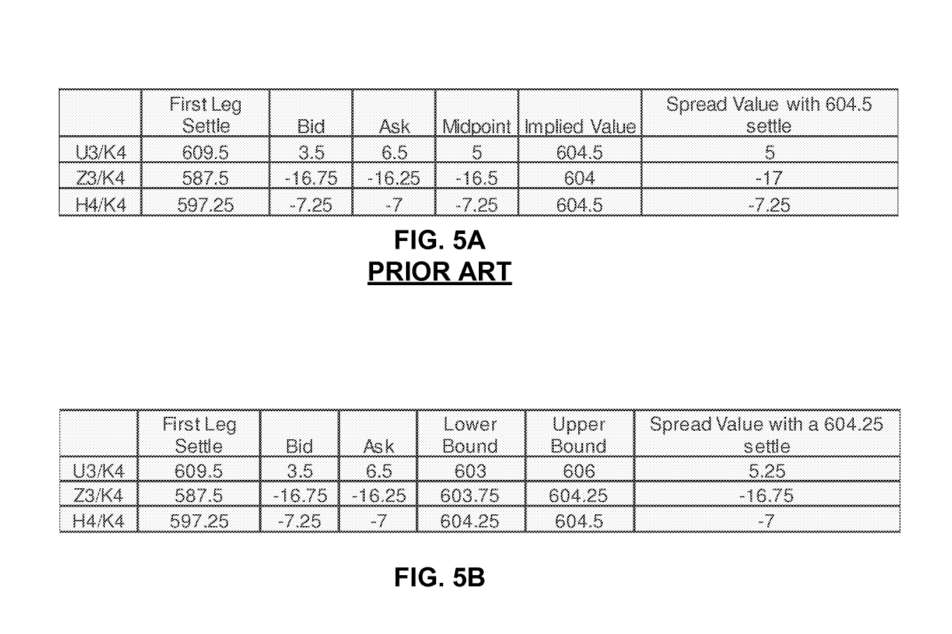

The disclosed embodiments may be useful in avoiding an issue presented by settlement price calculations based on a technique that calculates a median of the midpoints of the bid-offer range, or bid-ask market, for the various spread instruments. The approach based on the median of the midpoints may result in settlement values for a deferred month contract that lead to spread instrument values outside of the bid-offer range for the spread instrument. An example is described below in connection with FIG. 5A. The situation may occur when illiquid, inactive, or otherwise wide markets provide data that distorts the valuation of the deferred month contract. The inclusion of implied prices from such wider spread markets into the median calculation effectively reduces the contribution from other, more reliable, or otherwise tighter markets.

In some embodiments, the settlement price determination procedure may be configured to address the presence of a wide market through an adjustment during the boundary constraint determination. A wide market may lead to the boundary constraints crossing. In that event, then the boundary constraint associated with the wider market is discarded. The next best synthetic bid (or offer) of the synthetic market is then selected for use in the settlement price determination. The adjustment may be iterated until the boundary constraints no longer cross.

Use of the disclosed embodiments for settlement price determination may result in settlement prices that more accurately or closely reflect all market (e.g., bid/ask) activity for the spread contracts, while minimizing or reducing the effects of lower liquidity spread markets. Tighter markets may accordingly be rewarded at the expense of those markets with lower liquidity. This result may be useful because tighter markets may correspond with those considered to be more important or valuable to the market participants.

Although described below in connection with examples involving calendar spread instruments, the methods described herein are well suited for determining settlement prices for a variety of spread instruments, now available or hereafter developed. For example, the disclosed embodiments may be useful in connection with option spreads. While the disclosed embodiments are discussed in relation to grain futures, the disclosed embodiments may be applicable to contracts for other types of underlier commodity, equity, option, or futures trading system or market now available or later developed. The disclosed embodiments are also not limited to intra-market spread instruments, and accordingly may also be used in connection with inter-market spread instruments for contracts associated with different commodities.

While the disclosed embodiments may be described in reference to the CME, it will be appreciated that these embodiments are applicable to any Exchange. Such other Exchanges may include a clearing house that, like the CME Clearing House, clears, settles and guarantees all matched transactions in contracts of the Exchange occurring through its facilities. In addition, such clearing houses establish and monitor financial requirements for clearing members and conveys certain clearing privileges in conjunction with the relevant exchange markets.

The disclosed embodiments are also not limited to uses by a clearing house or Exchange for purposes of enforcing a performance bond or margin requirement. For example, a market participant may use the disclosed embodiments in a simulation or other analysis of a portfolio. In such cases, the settlement price may be useful as an indication of a value at risk and/or cash flow obligation rather than a performance bond. The disclosed embodiments may also be used by market participants or other entities to forecast or predict the effects of a prospective position on the margin requirement of the market participant.

The methods and systems described herein may be integrated or otherwise combined with various risk management methods and systems, such as the risk management methods and systems described in U.S. Patent Publication No. 2006/0265296 (“System and Method for Activity Based Margining”), the entire disclosure of which is incorporated by reference. For example, the methods and systems described herein may be configured as a component or module of the risk management systems described in the above-referenced patent publication. Alternatively or additionally, the disclosed methods may generate data to be provided to the systems described in the above-referenced patent publication. For example, the settlement prices determined by the disclosed embodiments may be incorporated into margin requirement(s) determined by the risk management method or system.

In one embodiment, the disclosed methods and systems are integrated or otherwise combined with the risk management system implemented by CME called Standard Portfolio Analysis of Risk™ (SPAM®). The SPAN system bases performance bond requirements on the overall risk of the portfolios using parameters as determined by CME's Board of Directors, and thus represents a significant improvement over other performance bond systems, most notably those that are “strategy-based” or “delta-based.” Further details regarding SPAN are set forth in the above-referenced patent publication.

The embodiments may be described in terms of a distributed computing system. The particular examples identify a specific set of components useful in a futures and options exchange. However, many of the components and inventive features are readily adapted to other electronic trading environments. The specific examples described herein may teach specific protocols and/or interfaces, although it should be understood that the principles involved may be extended to, or applied in, other protocols and interfaces.

It will be appreciated that the plurality of entities utilizing or involved with the disclosed embodiments, e.g. the market participants, may be referred to by other nomenclature reflecting the role that the particular entity is performing with respect to the disclosed embodiments and that a given entity may perform more than one role depending upon the implementation and the nature of the particular transaction being undertaken, as well as the entity's contractual and/or legal relationship with another market participant and/or the Exchange.

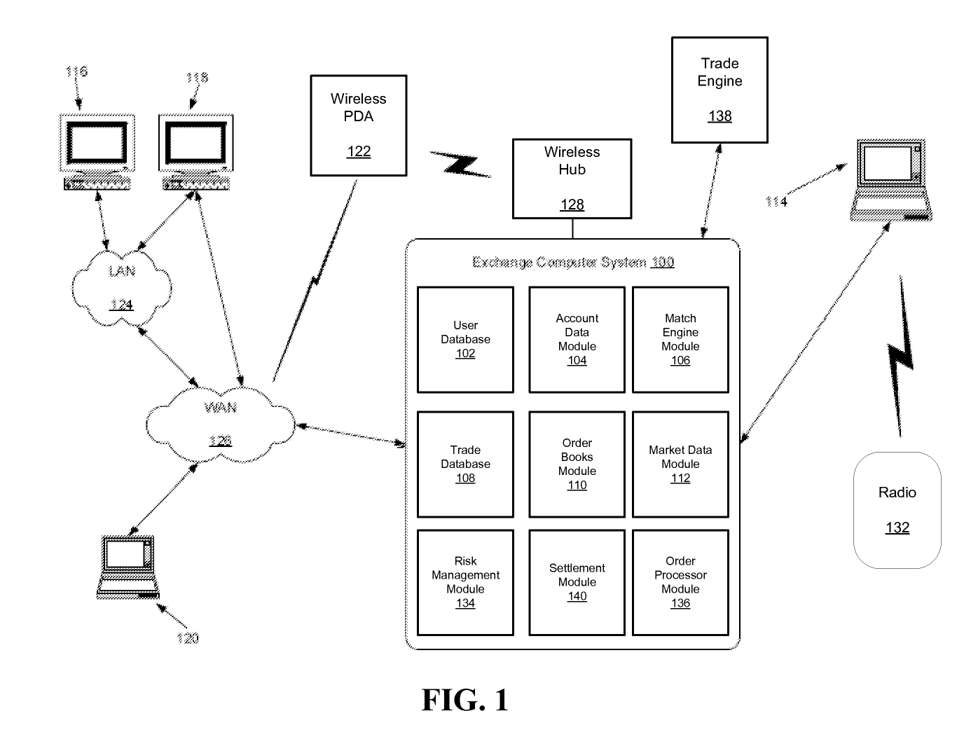

With reference now to the drawing figures, an exemplary trading network environment for implementing trading systems and methods is shown in FIG. 1. An exchange computer system 100 receives orders and transmits market data related to orders and trades to users, such as via wide area network 126 and/or local area network 124 and computer devices 114, 116, 118, 120 and 122, as described below, coupled with the exchange computer system 100.

Herein, the phrase “coupled with” is defined to mean directly connected to or indirectly connected through one or more intermediate components. Such intermediate components may include both hardware and software based components. Further, to clarify the use in the pending claims and to hereby provide notice to the public, the phrases “at least one of <A>, <B>, . . . and <N>” or “at least one of <A>, <B>, . . . <N>, or combinations thereof” are defined by the Applicant in the broadest sense, superseding any other implied definitions hereinbefore or hereinafter unless expressly asserted by the Applicant to the contrary, to mean one or more elements selected from the group comprising A, B, . . . and N, that is to say, any combination of one or more of the elements A, B, . . . or N including any one element alone or in combination with one or more of the other elements which may also include, in combination, additional elements not listed.

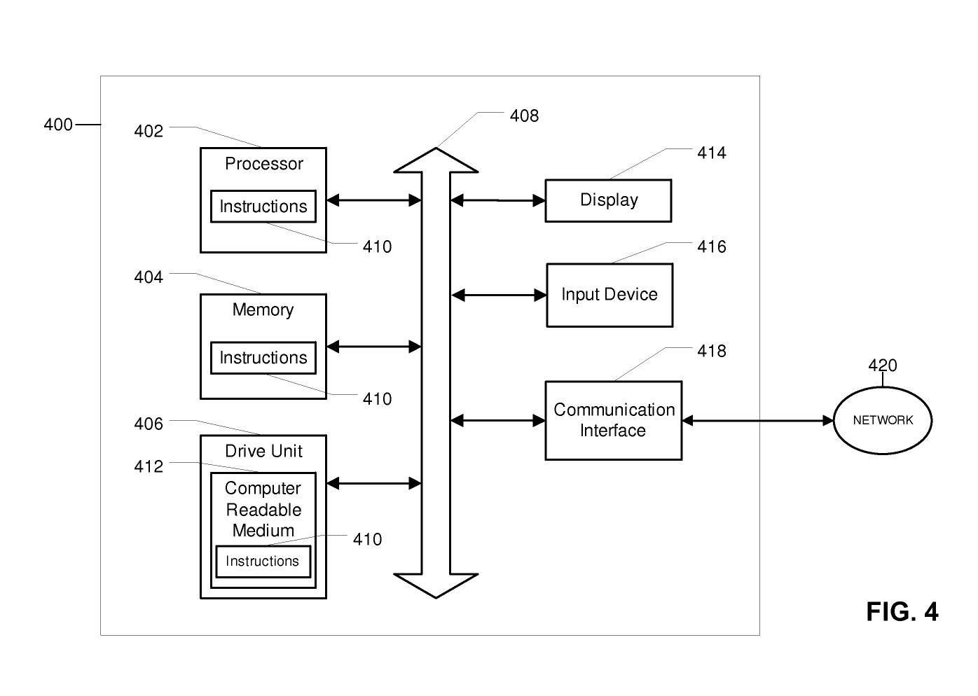

The exchange computer system 100 may be implemented with one or more mainframe, desktop or other computers, such as the computer 400 described below in connection with FIG. 4. A user database 102 may be provided which includes information identifying traders and other users of exchange computer system 100, such as account numbers or identifiers, user names and passwords. An account data module 104 may be provided which may process account information that may be used during trades.

A match engine module 106 may be included to match bid and offer prices and may be implemented with software that executes one or more algorithms for matching bids and offers. The match engine module 106 may be in communication with one or more of the local area network 124, the wide area network 126, or other elements of the exchange computer system 100 to receive data indicative of the orders from the market participants.

A trade database 108 may be included to store information identifying trades and descriptions of trades. In particular, a trade database may store information identifying the time that a trade took place and the contract price. An order book module 110 may be included to compute or otherwise determine current bid and offer prices. A market data module 112 may be included to collect market data and prepare the data for transmission to users. A risk management module 134 may be included to compute and determine a user's risk utilization in relation to the user's defined risk thresholds. The risk management module 134 may also be configured to determine risk assessments or exposure levels in connection with positions held by a market participant.

The risk management module 134 may be configured to administer, manage or maintain one or more margining mechanisms implemented by the exchange computer system 100. Such administration, management or maintenance may include managing a number of database records reflective of margin accounts of the market participants. In some embodiments, the risk management module 134 implements one or more aspects of the disclosed embodiments, including, for instance, PCA-based margining in connection with IRS portfolios, as described below.

An order processing module 136 may be included to decompose delta-based, spread instrument, bulk and other types of composite orders for processing by the order book module 110 and/or the match engine module 106. The order processing module 136 may also be used to implement one or more procedures related to clearing an order.

In the example of FIG. 1, the exchange computer system 100 also includes a settlement module 140 (or settlement processor or other payment processor) to provide one or more functions related to settling or otherwise administering transactions cleared by the Exchange. Settlement-related functions need not be limited to actions or events occurring at the end of a contract term. For instance, in some embodiments, settlement-related functions may include or involve daily or other MTM settlements for margining purposes. In some cases, the settlement module 140 may be configured to communicate with the trade database 108 (or the memory(ies) on which the trade database 108 is stored) and/or to determine a payment amount based on a spot price, the price of the futures contract or other financial instrument, or other price data, at various times. The determination may be made at one or more points in time during the term of the financial instrument in connection with a margining mechanism. For example, the settlement module 140 may be used to determine a MTM amount on a daily basis during the term of the financial instrument. Such determinations may also be made on a settlement date for the financial instrument for the purposes of final settlement.

In some embodiments, the settlement module 140 may be integrated to any desired extent with one or more of the other modules or processors of the exchange computer system 100. For example, the settlement module 140 and the risk management module 134 may be integrated to any desired extent. In some cases, one or more margining procedures or other aspects of the margining mechanism(s) may be implemented by the settlement module 140.

The exchange computer system 100 may include one or more additional modules or processors, including, for instance, a volume control module configured to, among other things, control the rate of acceptance of mass quote messages. It will be appreciated that concurrent processing limits may be defined by or imposed separately or in combination, as was described above, on one or more of the trading system components, including the user database 102, the account data module 104, the match engine module 106, the trade database 108, the order book module 110, the market data module 112, the risk management module 134, the order processing module 136, the settlement module 140, or other component of the exchange computer system 100.

The trading network environment shown in FIG. 1 includes exemplary computer devices 114, 116, 118, 120 and 122, which depict different exemplary methods or media by which a computer device may be coupled with the exchange computer system 100 or by which a user may communicate, e.g. send and receive trade or other information therewith. It will be appreciated that the types of computer devices deployed by traders and the methods and media by which they communicate with the exchange computer system 100 is implementation dependent and may vary and that not all of the depicted computer devices and/or means/media of communication may be used and that other computer devices and/or means/media of communications, now available or later developed may be used. Each computer device, which may include a computer 400 described in more detail below with respect to FIG. 4, may include a central processor that controls the overall operation of the computer and a system bus that connects the central processor to one or more conventional components, such as a network card or modem. Each computer device may also include a variety of interface units and drives for reading and writing data or files and communicating with other computer devices and with the exchange computer system 100. Depending on the type of computer device, a user can interact with the computer with a keyboard, pointing device, microphone, pen device or other input device now available or later developed.

An exemplary computer device 114 is shown directly connected to exchange computer system 100, such as via a T1 line, a common local area network (LAN) or other wired and/or wireless medium for connecting computer devices, such as the network 420 shown in FIG. 4 and described below with respect thereto. The exemplary computer device 114 is further shown connected to a radio 132. The user of radio 132, which may include a cellular telephone, smart phone, or other wireless proprietary and/or non-proprietary device, may be a trader or exchange employee. The radio user may transmit orders or other information to the exemplary computer device 114 or a user thereof. The user of the exemplary computer device 114, or the exemplary computer device 114 alone and/or autonomously, may then transmit the trade or other information to the exchange computer system 100.

Exemplary computer devices 116 and 118 are coupled with a local area network (“LAN”) 124 which may be configured in one or more of the well-known LAN topologies, e.g. star, daisy chain, etc., and may use a variety of different protocols, such as Ethernet, TCP/IP, etc. The exemplary computer devices 116 and 118 may communicate with each other and with other computer and other devices which are coupled with the LAN 124. Computer and other devices may be coupled with the LAN 124 via twisted pair wires, coaxial cable, fiber optics or other wired or wireless media. As shown in FIG. 1, an exemplary wireless personal digital assistant device (“PDA”) 122, such as a mobile telephone, tablet based compute device, or other wireless device, may communicate with the LAN 124 and/or the Internet 126 via radio waves, such as via WiFi, Bluetooth and/or a cellular telephone based data communications protocol. PDA 122 may also communicate with exchange computer system 100 via a conventional wireless hub 128.

FIG. 1 also shows the LAN 124 coupled with a wide area network (“WAN”) 126 which may be comprised of one or more public or private wired or wireless networks. In one embodiment, the WAN 126 includes the Internet 126. The LAN 124 may include a router to connect LAN 124 to the Internet 126. Exemplary computer device 120 is shown coupled directly to the Internet 126, such as via a modem, DSL line, satellite dish or any other device for connecting a computer device to the Internet 126 via a service provider therefore as is known. LAN 124 and/or WAN 126 may be the same as the network 420 shown in FIG. 4 and described below with respect thereto.

The operations of computer devices and systems shown in FIG. 1 may be controlled by computer-executable instructions stored on a non-transitory computer-readable medium. For example, the exemplary computer device 116 may include computer-executable instructions for receiving order information from a user and transmitting that order information to exchange computer system 100. In another example, the exemplary computer device 118 may include computer-executable instructions for receiving market data from exchange computer system 100 and displaying that information to a user.

Numerous additional servers, computers, handheld devices, personal digital assistants, telephones and other devices may also be connected to the exchange computer system 100. Moreover, the topology shown in FIG. 1 is merely an example and that the components shown in FIG. 1 may include other components not shown and be connected by numerous alternative topologies.

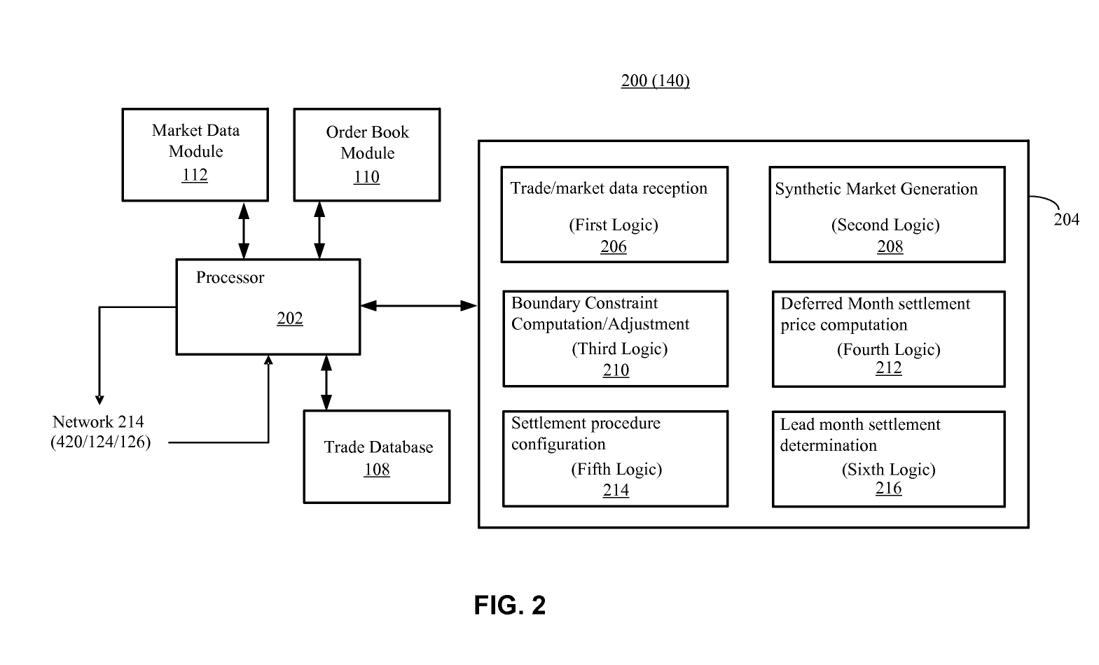

As shown in FIG. 1, the settlement module 140 of the exchange computer system 100 may implement one or more aspects of the settlement price determination techniques of the disclosed methods and systems, as will be described with reference to FIG. 2. It will be appreciated the disclosed embodiments may be implemented as a different or separate module of the exchange computer system 100, or a separate computer system coupled with the exchange computer system 100 so as to have access to margin account record, pricing, and/or other data. As described above, the disclosed embodiments may be implemented as a centrally accessible system or as a distributed system, e.g., where some of the disclosed functions are performed by the computer systems of the market participants.

As an intermediary, the Exchange 108 bears a certain amount of risk in each transaction that takes place. To that end, risk management mechanisms protect the Exchange 108 via the Clearing House. The Clearing House establishes clearing level performance bonds (margins) for all CME products and establishes minimum performance bond requirements for customers of CME products. A performance bond, also referred to as a margin, corresponds with the funds that must be deposited by a customer with his or her broker, by a broker with a clearing member or by a clearing member with the Clearing House, for the purpose of insuring the broker or Clearing House against loss on open futures or options contracts. This is not a part payment on a purchase. The performance bond helps to ensure the financial integrity of brokers, clearing members and the Exchange as a whole. The Performance Bond to Clearing House refers to the minimum dollar deposit required by the Clearing House from clearing members in accordance with their positions. Maintenance, or maintenance margin, refers to a sum, usually smaller than the initial performance bond, which must remain on deposit in the customer's account for any position at all times. The initial margin is the total amount of margin per contract required by the broker when a futures position is opened. A drop in funds below this level requires a deposit back to the initial margin levels, i.e. a performance bond call. If a customer's equity in any futures position drops to or under the maintenance level because of adverse price action, the broker must issue a performance bond/margin call to restore the customer's equity. A performance bond call, also referred to as a margin call, is a demand for additional funds to bring the customer's account back up to the initial performance bond level whenever adverse price movements cause the account to go below the maintenance.

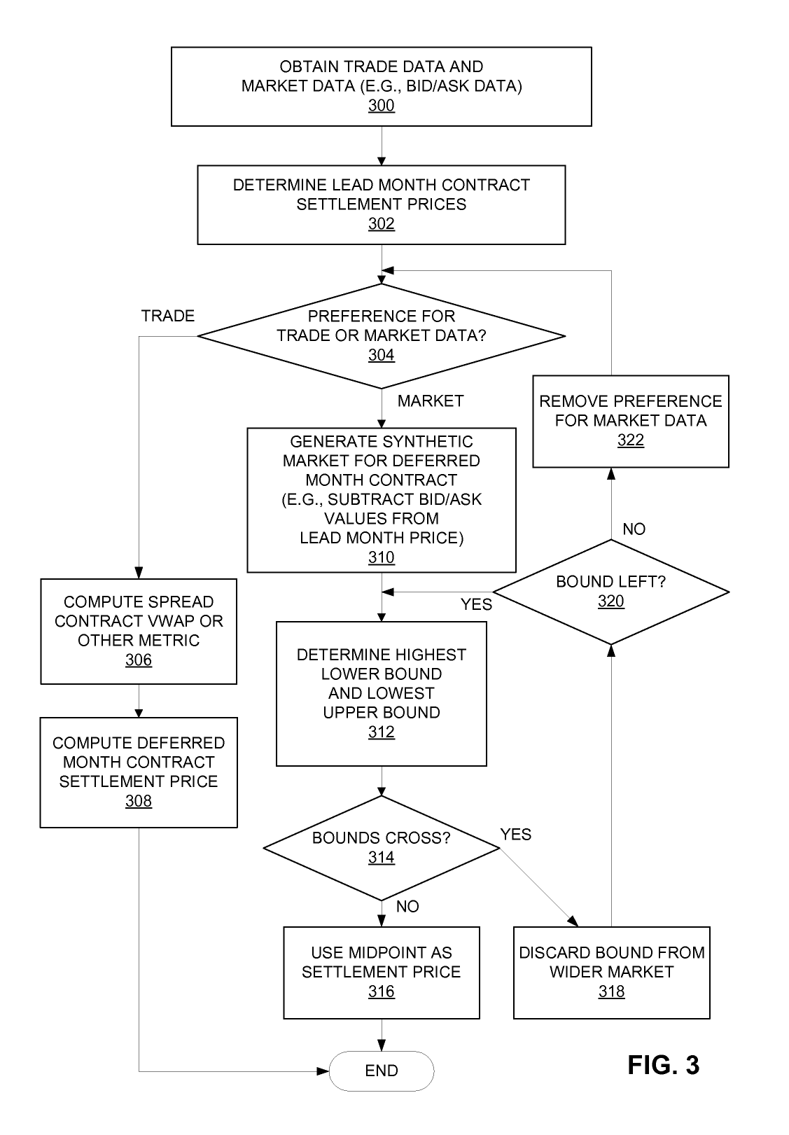

As described below in connection with the exemplary embodiments of FIGS. 2 and 3, one or more of the modules of the Exchange computer system 100 may be configured to determine settlement prices for constituent contracts, such as deferred month contracts, of spread instruments. In some cases, the outright market for the deferred month or other constituent contract may not be sufficiently active to provide market data (e.g., bid-offer data) and/or trade data. Spread instruments involving such contracts may nonetheless be made available by the Exchange. The market data from the spread instruments may then be used to determine a settlement price for the constituent contract. The settlement price may be determined through a boundary constraint-based technique based on the market data (e.g., bid-offer data) for the spread instrument, as described herein.

The boundary constraint-based procedure of the disclosed embodiments may be used in connection with spread instruments for which there is no or insufficient trade data (e.g., average trading price data) available. In cases where there is such price data available, the settlement price for the deferred month contract may be calculated as the difference between the settlement price of the lead month contract and the average trading price data.

The boundary constraint-based technique may use the bid-offer data for each spread instrument to generate a synthetic market for the constituent contract. The bid of the spread instrument provides a lower bound on the price of the constituent contract, while the offer (or ask) provides an upper bound. Because multiple spread instruments include the constituent contract, a set of lower bounds and a set of upper bounds are provided. Once the two sets of bounds are determined, the boundary constraints on the settlement price are determined as the best (highest) bound from the set of lower bounds and the best (lowest) bound from the set of upper bounds. The boundary constraints may then be averaged to calculate a settlement price. The resulting settlement price will not be outside of any of the posted bid/ask markets for the spread instruments, provided that the lower bound and upper bound do not cross. If the bounds cross, the boundary constraint associated with the wider spread market is discarded, and the boundary constraint determination is implemented again until the bounds no longer cross.

The boundary constraint-based technique of the disclosed embodiments may be based on market data (e.g., bid-offer or bid-ask market data) for all of the spread instruments having the constituent contract. The synthetic bid/ask market for the constituent contract to be valued may incorporate bid/ask information from any number of spread markets.

The boundary constraint-based technique of the disclosed embodiments may also include other market data. For instance, in some embodiments, market data for the contract to be settled may be incorporated into the boundary constraint determination. In calendar spread instrument examples, bid-offer data for a deferred month contract may be obtained and incorporated into the two sets of the synthetic market used to determine the lowest upper bound and the highest lower bound. For example, the best offer on the order book for the deferred month contract may be used as one of the candidates for the lowest upper bound. The best bid on the order book may be used as one of the candidates for the highest lower bound.

The boundary constraint-based technique of the disclosed embodiments may include or be combined with other settlement price determination techniques. For example, certain markets or market conditions may warrant the use of a technique other than the boundary constraint-based technique. In some embodiments, a settlement price for a lead month or active contract of a spread instrument may be calculated using a procedure that involves computing a volume weighted average price (VWAP) of trades for that contract. VWAP and other trade data-based techniques may also be used to settle contracts other than the lead month contract (or active contract) of the spread instrument. In some embodiments, an option to use trade data in, e.g., a VWAP computation, is provided as an alternative to the boundary constraint-based technique. For example, if sufficient trade data is available in the outright market for the contract to be settled, the settlement price may be determined based on such trade data. Alternatively or additionally, if the option to use the trade data is not initially selected, the settlement price may nonetheless be determined based on such trade data if the boundary constraint-based technique is not successful. This may occur if all of the spread instrument markets are open ended, as described below. If trade data for the contract to be settled is insufficient or unavailable, trade data for another contract (e.g., a preceding month contract) may be used to imply a settlement price for the constituent contract.

In some embodiments, a pre-defined width threshold may also be used to determine which technique and/or data is used to determine a settlement price. For example, a pre-defined width threshold may be used to determine whether the market data in the outright market for the contract to be settled is used.

The settlement price determination techniques of the disclosed embodiments may be iteratively implemented to cover calendar month spread instruments having different deferred month contracts. The disclosed embodiments are first applied to a number of spread instruments having a first deferred month contract in common. The settlement price determined for the first deferred month contract may then be used to settle deferred month contracts of spread instruments having the first deferred month contract as the lead month contract. The boundary constraint-based procedure may thus be iteratively performed to address a number of different spread instruments having different lead month contracts.

FIG. 2 depicts a block diagram of a system 200 operative to determine a settlement price for a constituent contract of a plurality of spread instruments. In some embodiments, the system 200 may correspond with, or implement, the settlement module 140 and/or other module of the exchange computer system 100 (e.g., the risk management module 134). The system 200 may thus be implemented as part of the exchange computer system 100 described above.

One or more of the above-described modules of the Exchange computer system 100 may be used to gather or obtain data to support the settlement price determination, as well as a subsequent margin requirement determination by the system 200. For example, the order book module 110 and/or the market data module 112 may be used to receive, access, or otherwise obtain market data, such as bid-offer values of orders currently on the order books. The trade database 108 may be used to receive, access, or otherwise obtain trade data indicative of the prices and volumes of trades that were recently executed in a number of markets. In some cases, transaction data (and/or bid/ask data) may be gathered or obtained from open outcry pits and/or other sources and incorporated into the trade and market data from the electronic trading system(s).

The system 200 includes a processor 202 and a memory 204 coupled therewith which may be implemented as a processor 402 and memory 404 as described below with respect to FIG. 4. The system 200 further includes first logic 206 stored in the memory 204 and executable by the processor 202 to cause the processor 202 to obtain market data indicative of bid-offer values for the plurality of spread instruments. The market data may include data indicative of a best bid and a best offer on the order book for each spread instrument. In some cases, the spread instruments are calendar spread instruments having a lead month contract and a deferred month contract as the constituent contract to be settled. Market data for other types of spread instruments and, thus, other types of constituent contracts, may be obtained. The system 200 is not limited to settling constituent contracts of calendar spread instruments.

The first logic 206 may also be configured to obtain trade data indicative of recent trade activity in each spread instrument market. The trade data may include data indicative of price and volume for recent trades. Further trade data may be obtained for the markets of the constituent contracts. For example, trade data may be obtained for an active contract, such as a lead month contract, of each calendar spread instrument. The trade data may also be obtained, if available, for the other constituent contract, e.g., the deferred month contract, of the spread instrument. Such trade data may be used to determine the manner in which the constituent contract is to be settled. For example, if sufficient trade data is available for the constituent contract itself, then the trade data may be used to determine a settlement price. The sufficiency of the trade data may turn on the volume, timing, price information (e.g., relative to the current market data), and/or other characteristic of the trade data.

In some embodiments, the market data obtained by the first logic 206 includes market data for the market (e.g., the outright market) for the constituent contract to be settled. Such market data may be indicative of the best bid and the best offer for the constituent contract itself.

The system 200 further includes second logic 208 stored in the memory 204 and executable by the processor 202 to cause the processor 202 to generate synthetic market data for the constituent contract. The synthetic market data is generated based on the bid-offer values for the spread instruments having the constituent contract. The synthetic market data is also based on a respective settlement price for an active contract of each spread instrument. The second logic 208 may be configured to subtract the bid-offer values of the spread instrument from the respective settlement price for the lead month contract of the spread instrument. For example, for a calendar month spread instrument having a lead month contract trading at 584.50 and with bid and offer values of −14.5 and −12.5, respectively, then the synthetic market data for the deferred month contract has a synthetic ask (or offer) of 584.5−(−14.5) or 599, and a synthetic bid of 584.5−(−12.5) or 597. Such synthetic bid and offer values for the constituent contract are determined for each spread instrument having the constituent contract. The synthetic market data may thus include a set of synthetic bid values and a set of synthetic offer values. Each set includes an element for each spread instrument having the constituent contract to be settled.

The system 200 further includes third logic 210 stored in the memory 204 and executable by the processor 202 to cause the processor 202 to determine boundary constraints on the settlement price for the constituent contract based on the synthetic market data. The sets of synthetic bid values and synthetic offer values for the constituent contract may be evaluated to determine the boundary constraints. The third logic 210 may be further executable by the processor 202 to determine a highest lower bound of the settlement price for the constituent contract based on the synthetic market data, and determine a lowest upper bound of the settlement price for the constituent contract based on the synthetic market data. The highest lower bound may be determined by selecting the highest synthetic bid value from the set of synthetic bid values. The lowest upper bound may be determined by selecting the lowest synthetic offer value from the set of synthetic offer values.

The system 200 further includes fourth logic 212 stored in the memory 204 and executable by the processor 202 to cause the processor 202 to compute the settlement price for the constituent contract based on the boundary constraints. The fourth logic 212 is further executable by the processor 202 to calculate an average or midpoint of the highest lower bound and the lowest upper bound to determine the settlement price for the constituent contract. The settlement price of the constituent contract may thus be the midpoint of the boundary constraints provide as the output data of the third logic 210. If the boundary constraints are equal to one another, the constituent contract may settle at that value. The fourth logic 212 may be configured to round up or down to a nearest market value.

The boundary constraints on the settlement price may, and often will, be based on the market data for different spread instruments. As a result, the boundary constraints computed by the third logic 210 may cross. The boundary constraints cross when the highest lower bound is higher than the lowest upper bound. The likelihood of the boundary constraints crossing increases as the dislocation of the spread instrument markets increases.

Rather than allow the settlement price to be determined by crossed boundary constraints, the third logic 210 may be configured to implement an adjustment to the boundary constraints. If the highest lower bound and the lowest upper bound cross, the third logic 210 is further executable by the processor 202 to discard one of the boundary constraints. Of the highest lower bound and the lowest upper bound, the boundary constraint associated with a wider market based on the bid-offer data is discarded. The third logic 210 is then executed again by the processor 202 to perform another iteration of determining the highest lower bound and determining the lowest upper bound. The adjustment and determination of the boundary constraints are iterated until the boundary constraints no longer cross.

In the embodiment of FIG. 2, the system 200 further includes fifth logic 214 stored in the memory 204 and executable by the processor 202 to cause the processor 202 to configure the manner in which the settlement price is determined. The settlement procedure may be configured to use the boundary constraint-based technique as a default procedure and/or in certain circumstances. For example, the fifth logic 214 may cause the processor 202 to evaluate the trade data in one or more markets (e.g., the market of the contract to be settled) to determine if sufficient trade data is available to derive a settlement price therefrom (e.g., using a VWAP technique).

The fifth logic 213 may additionally or alternatively be executable by the processor 202 to cause the processor 202 to reconfigure the settlement procedure in the event that the boundary constraint-based technique is unsuccessful. For instance, the technique may not be successful if all of the synthetic market data is discarded for one of the boundary constraints. In some cases, each element of the set of synthetic bids (or offers) results in crossed boundary constraints. The fifth logic 214 may then cause the processor 202 to switch to an alternative technique based on a metric other than the bid-offer values of the spread instrument. In such cases, the fourth logic 212 may then be further executable by the processor 202 to calculate the settlement price for the constituent contract based on the other metric. For example, trade data for the constituent market, or another market (e.g., a preceding month contract or other similar contract) may be used. A switch to a different technique may be useful in certain market conditions, such as when each spread instrument market is one-sided in the same manner (e.g., when the spread markets are all “bid only” markets or are all “ask only” markets), which would lead to only an upper bound or only a lower bound.

The fifth logic 214 may be executable by the processor 214 to configure the settlement price determination at other times. For instance, the configuration may involve an initial election as to whether to determine the settlement price of the constituent contract based on the market data indicative of the bid-offer values for the plurality of spread instruments or based on trade data indicative of trades involving the constituent contract or another month contract.

The embodiment of FIG. 2 also includes sixth logic 216 stored in the memory 204 and executable by the processor 202 to cause the processor 202 to determine a settlement price of an active contract of the spread instruments. The active contract may be settled in accordance with the trade data in the outright market for the active contract. For example, the trade data may be processed in accordance with a VWAP procedure to determine the settlement price. Other procedures may be used. For example, the midpoint of the current bid/ask market, the midpoint of the low bid and the high ask of the closing range, or the midpoint of the high bid and the low ask of the closing range, may be used. If there is insufficient trade data for the active contract, the sixth logic 216 may cause the processor 202 to rely on the settlement price determined via the boundary constraint-based procedure. The boundary constraint-based procedure may thus be iteratively implemented until the constituent contracts are settled.

The above-described logic may be arranged in any number of modules or other logic units. For example, the fifth logic 214 may be integrated with the fourth logic 212 to any desired extent. The sixth logic 216 and the first logic 206 may also be integrated to any desired extent. Fewer, alternative, or additional logic units may be included.

Referring to FIG. 3, a computer-implemented method is configured in accordance with one embodiment to determine a settlement price for a constituent contract of a plurality of spread instruments. The computer-implemented method may be implemented to any desired extent by the system 200 of FIG. 2, the system described in connection with FIG. 4, the processor 202 (FIG. 2), and/or any other processor. In some cases, the method is implemented by an exchange. Alternatively, the method is implemented by a market participant or other entity for which the margin requirement may be representative of a value at risk (or potential value at risk).

The computer-implemented method may begin with the reception (block 300) of market data indicative of bid-offer values for the plurality of spread instruments. Trade data indicative of recent trades executed in one or more markets may also be obtained. For example, the trade data may be indicative of the trades for the active contracts of the spread instruments. Trade data for the deferred month or other contract to be settled may also be obtained, if available. Trade data for the spread instrument may also be obtained, if available. The trade data may be recent (e.g., within a predetermined window of time, such as a last minute, at the end of the trading session and/or before the predetermined window).

In the embodiment of FIG. 3, the active contracts of the spread instruments, such as the lead month contracts, are settled (block 302) using the trade data. The settlement prices of the active contracts may be determined through a VWAP or other computation. Alternatively or additionally, one or more of the active contracts are settled through previous iterations of the boundary constraint-based procedure. The active contracts may thus be settled based on market data in some cases. Each active contract may be settled using a settlement procedure appropriate for the trade and/or market data available.

The availability, quality, and other characteristics of the trade data and market data for the other constituent contract (e.g., the deferred month contract) of the spread instruments are evaluated in a decision block 304. In this example, the evaluation of the trade and market data supports a determination of whether there is a preference to base the settlement price on market data or trade data. For instance, if trade data in the outright market for the constituent contract is available (and, e.g., sufficiently current), then the contract may be settled based on such trade data. In this example, the VWAP or other metric for the trade data is computed (block 306) and the settlement price is computed (block 308) based on the metric. The one or more criteria by which the trade data is deemed qualified for use in settling the contract may vary.

If trade data is not available or otherwise insufficient or inadequate, then control passes to a block 310 for implementation of the boundary constraint-based settlement procedure. Synthetic market data is generated for the constituent contract based on the market data (e.g., bid-offer values) for the spread instrument and based on a respective settlement price for an active contract of each spread instrument. As shown in the examples described below, the synthetic market data may be generated by, for each spread instrument, subtracting the bid-offer values from the respective settlement price for the active contract. The settlement prices for the active contracts may be determined previously (block 302) or provided via another component of the exchange (e.g., the trade database 108 (FIG. 2)).

Boundary constraints on the settlement price for the constituent contract are then determined (block 312) based on the synthetic market data. The best bid and the best offer in the synthetic market data may be selected to determine the highest lower bound and the lowest upper bound on the settlement price.

The boundary constraints may then be evaluated in a decision block 314 to determine whether the lower bound and the upper bound cross. If the lower bound does not exceed the upper bound (i.e., the bounds do not cross), then control passes to a block 316 in which the average or midpoint of the bounds is calculated and used as the settlement price for the constituent contract. The settlement price may be computed based on the boundary constraints in other manners, including, for instance, a weighted average or other computation that incorporates data into the computation other than the boundary constraints (e.g., trade data in the outright market for the constituent market).

If the boundary constraints cross, then control passes to a block 318 in which the spread markets from which the bounds originated are evaluated. The bound that originated from the wider of the two markets is discarded. The synthetic market data for that market is no longer used in the boundary constraint determination. In some cases, the spread market is disqualified from only the upper or lower bound determination that led to the crossed boundary constraints. In other cases, the spread market is disqualified from both bound determinations. If the markets are of equal width, then both bounds may be discarded.

In the embodiment of FIG. 3, the synthetic market data is evaluated in a decision block 320 to determine whether synthetic bids or offers remain in the synthetic market data after the discarding of the bound. If the sets of synthetic bids (or offers) are not empty, then control returns to the block 312 for another iteration of the boundary constraint determination.

If the last synthetic bid (or offer) has been discarded, then control passes to a block 322 in which a preference to use the market data to settle the constituent contract is removed. The settlement price may then be determined based on a metric other than the bid-offer values of the spread instruments. For example, a flag may be set (or removed) to re-configure the method to use the trade data available instead of the market data. In another example, the net change of a contract that preceded the contract to be settled in the settlement order may be used. Implementation of the decision block 304 may then lead to computation of the VWAP of the trade data (or other metric based on the trade data) in the block 306 for use in the settlement determination. The metric may involve or otherwise include trade data associated with another contract than the constituent contract. For example, the settlement price may be inferred or calculated based on trade data for a previous month or other contract similar to the contract to be settled.

Referring to FIG. 4, an illustrative embodiment of a general computer system 400 is shown. The computer system 400 can include a set of instructions that can be executed to cause the computer system 400 to perform any one or more of the methods or computer based functions disclosed herein. The computer system 400 may operate as a standalone device or may be connected, e.g., using a network, to other computer systems or peripheral devices. Any of the components discussed above may be a computer system 400 or a component in the computer system 400. The computer system 400 may implement a match engine on behalf of an exchange, such as the Chicago Mercantile Exchange, of which the disclosed embodiments are a component thereof.

In a networked deployment, the computer system 400 may operate in the capacity of a server or as a client user computer in a client-server user network environment, or as a peer computer system in a peer-to-peer (or distributed) network environment. The computer system 400 can also be implemented as or incorporated into various devices, such as a personal computer (PC), a tablet PC, a set-top box (STB), a personal digital assistant (PDA), a mobile device, a palmtop computer, a laptop computer, a desktop computer, a communications device, a wireless telephone, a land-line telephone, a control system, a camera, a scanner, a facsimile machine, a printer, a pager, a personal trusted device, a web appliance, a network router, switch or bridge, or any other machine capable of executing a set of instructions (sequential or otherwise) that specify actions to be taken by that machine. In a particular embodiment, the computer system 400 can be implemented using electronic devices that provide voice, video or data communication. Further, while a single computer system 400 is illustrated, the term “system” shall also be taken to include any collection of systems or sub-systems that individually or jointly execute a set, or multiple sets, of instructions to perform one or more computer functions.

As illustrated in FIG. 4, the computer system 400 may include a processor 402, e.g., a central processing unit (CPU), a graphics processing unit (GPU), or both. The processor 402 may be a component in a variety of systems. For example, the processor 402 may be part of a standard personal computer or a workstation. The processor 402 may be one or more general processors, digital signal processors, application specific integrated circuits, field programmable gate arrays, servers, networks, digital circuits, analog circuits, combinations thereof, or other now known or later developed devices for analyzing and processing data. The processor 402 may implement a software program, such as code generated manually (i.e., programmed).

The computer system 400 may include a memory 404 that can communicate with a drive unit 406 and other components of the system 400 via a bus 408. The memory 404 may be a main memory, a static memory, or a dynamic memory. The memory 404 may include, but is not limited to computer readable storage media such as various types of volatile and non-volatile storage media, including but not limited to random access memory, read-only memory, programmable read-only memory, electrically programmable read-only memory, electrically erasable read-only memory, flash memory, magnetic tape or disk, optical media and the like. In one embodiment, the memory 404 includes a cache or random access memory for the processor 402. In alternative embodiments, the memory 404 is separate from the processor 402, such as a cache memory of a processor, the system memory, or other memory. The memory 404 may be an external storage device or database for storing data. Examples include a hard drive, compact disc (“CD”), digital video disc (“DVD”), memory card, memory stick, floppy disc, universal serial bus (“USB”) memory device, or any other device operative to store data.

The memory 404 is operable to store instructions 410 executable by the processor 402. The functions, acts or tasks illustrated in the figures or described herein may be performed by the programmed processor 402 executing the instructions 410 stored in the memory 404. The instructions 410 may be loaded or accessed from a computer-readable storage medium 412 in the drive unit 406 or other data storage device. The functions, acts or tasks are independent of the particular type of instructions set, storage media, processor or processing strategy and may be performed by software, hardware, integrated circuits, firm-ware, micro-code and the like, operating alone or in combination. Likewise, processing strategies may include multiprocessing, multitasking, parallel processing and the like.

As shown, the computer system 400 may further include a display unit 414, such as a liquid crystal display (LCD), an organic light emitting diode (OLED), a flat panel display, a solid state display, a cathode ray tube (CRT), a projector, a printer or other now known or later developed display device for outputting determined information. The display 414 may act as an interface for the user to see the functioning of the processor 402, or specifically as an interface with the software stored in the memory 404 or in the drive unit 406.

Additionally, the computer system 400 may include an input device 416 configured to allow a user to interact with any of the components of system 400. The input device 416 may be a number pad, a keyboard, or a cursor control device, such as a mouse, or a joystick, touch screen display, remote control or any other device operative to interact with the system 400.

In a particular embodiment, as depicted in FIG. 4, the computer system 400 may also include an optical or other disk drive unit as the drive unit 406. The disk drive unit 406 may include the computer-readable storage medium 412 in which one or more sets of instructions 410, e.g. software, can be embedded. Further, the instructions 410 may embody one or more of the methods or logic as described herein. In a particular embodiment, the instructions 410 may reside completely, or at least partially, within the memory 404 and/or within the processor 402 during execution by the computer system 400. The memory 404 and the processor 402 also may include computer-readable storage media as discussed above.

The present disclosure contemplates a computer-readable medium that includes instructions 410 or receives and executes instructions 410 responsive to a propagated signal, which may be received via a communication interface 418. The system 400 may be connected to a network 420 to communicate voice, video, audio, images or any other data over the network 420. Further, the instructions 412 may be transmitted or received over the network 420 via a communication interface 418. The communication interface 418 may be a part of the processor 402 or may be a separate component. The communication interface 418 may be created in software or may be a physical connection in hardware. The communication interface 418 is configured to connect with a network 420, external media, the display 414, or any other components in system 400, or combinations thereof. The connection with the network 420 may be a physical connection, such as a wired Ethernet connection or may be established wirelessly as discussed below. Likewise, the additional connections with other components of the system 400 may be physical connections or may be established wirelessly.

The network 420 may include wired networks, wireless networks, or combinations thereof. The wireless network may be a cellular telephone network, an 802.11, 802.16, 802.20, or WiMax network. Further, the network 420 may be a public network, such as the Internet, a private network, such as an intranet, or combinations thereof, and may utilize a variety of networking protocols now available or later developed including, but not limited to TCP/IP based networking protocols.

Embodiments of the subject matter and the functional operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer program products, i.e., one or more modules of computer program instructions encoded on a computer readable medium for execution by, or to control the operation of, data processing apparatus. While the computer-readable medium is shown to be a single medium, the terms “computer-readable medium” and “computer-readable storage medium” include a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the methods or operations disclosed herein. The computer-readable storage medium may be or include a machine-readable storage device, a machine-readable storage substrate, a memory device, or a combination of one or more of them. The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them.

In a particular non-limiting, exemplary embodiment, the computer-readable medium can include a solid-state memory such as a memory card or other package that houses one or more non-volatile read-only memories. Further, the computer-readable medium can be a random access memory or other volatile re-writable memory. Additionally, the computer-readable medium can include a magneto-optical or optical medium, such as a disk or tapes or other storage device to capture carrier wave signals such as a signal communicated over a transmission medium. A digital file attachment to an e-mail or other self-contained information archive or set of archives may be considered a distribution medium that is a tangible storage medium. Accordingly, the disclosure is considered to include any one or more of a computer-readable medium or a distribution medium and other equivalents and successor media, in which data or instructions may be stored.

In an alternative embodiment, dedicated hardware implementations, such as application specific integrated circuits, programmable logic arrays and other hardware devices, can be constructed to implement one or more of the methods described herein. Applications that may include the apparatus and systems of various embodiments can broadly include a variety of electronic and computer systems. One or more embodiments described herein may implement functions using two or more specific interconnected hardware modules or devices with related control and data signals that can be communicated between and through the modules, or as portions of an application-specific integrated circuit. Accordingly, the present system encompasses software, firmware, and hardware implementations.

In accordance with various embodiments of the present disclosure, the methods described herein may be implemented by software programs executable by a computer system. Further, in an exemplary, non-limited embodiment, implementations can include distributed processing, component/object distributed processing, and parallel processing. Alternatively, virtual computer system processing can be constructed to implement one or more of the methods or functionality as described herein.

Although the present specification describes components and functions that may be implemented in particular embodiments with reference to particular standards and protocols, the invention is not limited to such standards and protocols. For example, standards for Internet and other packet switched network transmission (e.g., TCP/IP, UDP/IP, HTML, HTTP, HTTPS) represent examples of the state of the art. Such standards are periodically superseded by faster or more efficient equivalents having essentially the same functions. Accordingly, replacement standards and protocols having the same or similar functions as those disclosed herein are considered equivalents thereof.

The disclosed computer programs (also known as a program, software, software application, script, or code) can be written in any form of programming language, including compiled or interpreted languages. The disclosed computer programs can be deployed in any form, including as a standalone program or as a module, component, subroutine, or other unit suitable for use in a computing environment. Such computer programs do not necessarily correspond to a file in a file system. Such programs can be stored in a portion of a file that holds other programs or data (e.g., one or more scripts stored in a markup language document), in a single file dedicated to the program in question, or in multiple coordinated files (e.g., files that store one or more modules, sub programs, or portions of code). Such computer programs can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and anyone or more processors of any kind of digital computer. Generally, a processor may receive instructions and data from a read only memory or a random access memory or both. The essential elements of a computer are a processor for performing instructions and one or more memory devices for storing instructions and data. Generally, a computer may also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio player, a Global Positioning System (GPS) receiver, to name just a few. Computer readable media suitable for storing computer program instructions and data include all forms of non volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, embodiments of the subject matter described in this specification can be implemented on a device having a display, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Embodiments of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

Further details regarding boundary constraint-based settlement technique of the disclosed embodiments are set forth below in connection with several examples.

FIG. 5A depicts a potential problem with non-boundary constraint-based settlement. In this example, the midpoints of the spread markets are used to derive a deferred month settlement. The example shows how the settlement price can be distorted by an illiquid and wide market. In this case, the corn U3/K4 (September 2003/May 2014) market is the widest of the markets having the K4 contract to be settled. The U3/K4 spread instrument may not be of as much interest to the market participants as the other two spread instruments having the K4 contract, the corn Z3/K4 (December 2013/May 2014) and H4/K4 (March 2014/May 2014) instruments in this example. In the midpoint-based approach, the midpoint of each spread market is computed and used to calculate an implied value for the contract to be settled. The median or average of the midpoints is then calculated to settle the K4 contract. In this example, the median of the midpoints (e.g., 604.5, 604, 604.5) is 604.5. With that settlement price for the K4 contract, the imputed values of the spread instruments are 5, −17, and −7.25. The problem is presented in connection with the value (−17) for the Z3/K4 spread instrument, which lies outside of the posted bid-offer values (−16.75, −16.25) for the spread instrument.

One alternative to the midpoint-based approach would be to only use the midpoint of the tightest bid/ask spread markets to settle the constituent contract. In some cases, however, completely disregarding a market due solely to its width may lead to other inaccuracies or issues. For example, if two spread markets have identical width, there may be difficulty in deciding which to use. Additionally, using the tightest market may not guarantee that a wider market will not be violated. There may be an appropriate settlement value that does not violate any markets. Moreover, the midpoint-based approach may nonetheless still result in settlement values that impute a value of the spread instrument outside of the posted bid/ask market.

FIG. 5B depicts the application of one embodiment of the boundary constraint-based approach to the spread instrument data processed in FIG. 5A. In the boundary constraint-based approach, all spread bid/ask information is used to create synthetic bid/ask markets in the contract to be settled. For example, the current bid (3.5) and ask (6.5) values for the U3/K4 spread instrument are subtracted from the settlement price for U3, the active contract or first leg (609.5). The subtractions provide a lower bound (603) and an upper bound (606) for the price of the constituent contract to be settled. Lower and upper bounds are computed for each of the spread instruments, creating a set of lower bounds (603, 603.75, 604.25) and a set of upper of bounds (606, 604.25, 604.5). In other embodiments, the actual bid and ask data in the outright contract (K4) to be settled may be added to the two sets to further define the synthetic bid/ask markets.

The best (highest) bid is selected from the set of lower bounds (604.25), and the best (lowest) offer is selected from the set of upper bounds (also 604.25). The midpoint or average of these two values may then be calculated to provide the settlement price for the K4 contract. The settlement price (604.25) imputes a value of each spread instrument that does not fall outside of any posted bid/ask markets. The settlement price will not impute a value of one of the spread instruments outside of the posted bid/ask values provided that the lower bound and upper bound do not cross.

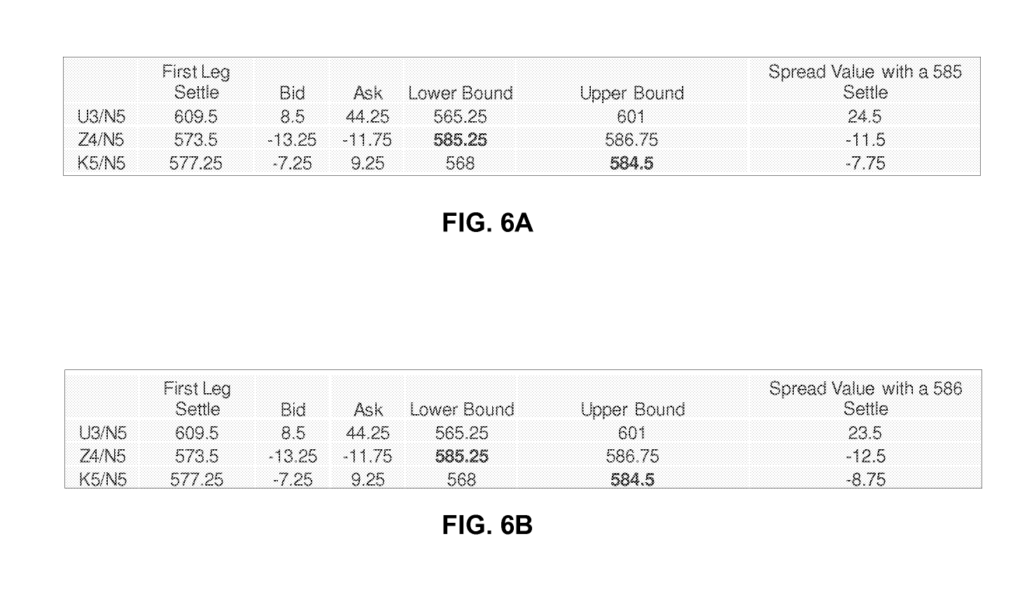

FIG. 6A provides an example of the application of one embodiment of the boundary constraint-based technique to market data that presents bounds that cross. The synthetic market data is generated for the deferred month contract (corn July 2015, or N5) of three spread instruments. The sets of lower and upper bounds are evaluated to select the best lower bound (585.25) and the best upper bound (584.5). Because the bounds cross, the midpoint or average of the bounds (585) leads to two of the imputed values of the spread instruments falling outside of the posted bid/ask market values, as shown in the corn May 2015/July 2015 (K5/N5) instrument and the corn December 2014/July 2015 (Z4/N5) instrument. One of the violated markets is a relatively tight market that may be considered by the market participants to be more important or valuable.

As shown in FIG. 6B, the boundary constraints are adjusted to address this situation. The width of the bid/ask markets from which the two bounds originated are assessed. The lower bound originated from the synthetic market data based on the Z4/N5 spread instrument, which has a width of abs(−13.25−(−11.75)) or 1.5. The upper bound originated from the synthetic market data based on the K5/N5 spread instrument, which has a width of abs(−7.25-9.25) or 16.5. The upper bound originated from the wider market, and is accordingly discarded from consideration.

With one of the upper bounds discarded from the set of upper bounds, a new best upper bound is determined (586.75). Because this bound does not cross with the retained lower bound, the average or midpoint of the two bounds may be calculated (586) to determine the settlement price. If the new boundary constraints cross, the adjustment is repeated until boundary constraints are found that do not cross. As shown in FIG. 6B, only the wide bid/ask market remains violated by the new settlement price.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

While this specification contains many specifics, these should not be construed as limitations on the scope of the invention or of what may be claimed, but rather as descriptions of features specific to particular embodiments of the invention. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings and described herein in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is provided to comply with 37 C.F.R. §1.72(b) and is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

It is therefore intended that the foregoing detailed description be regarded as illustrative rather than limiting, and that it be understood that it is the following claims, including all equivalents, that are intended to define the spirit and scope of this invention.

1. A computer implemented method for determining a settlement price for a constituent contract of a plurality of spread instruments, the plurality of spread instruments having the constituent contract in common, the computer implemented method comprising:
obtaining market data indicative of bid-offer values for the plurality of spread instruments;
generating, by a processor, synthetic market data for the constituent contract based on the bid-offer values and based on a respective settlement price for an active contract of each spread instrument of the plurality of spread instruments;
determining boundary constraints on the settlement price for the constituent contract based on the synthetic market data; and
computing, by the processor, the settlement price for the constituent contract based on the boundary constraints.

2. The computer implemented method of claim 1 wherein generating the synthetic market comprises subtracting the bid-offer values from the respective settlement price for the active contract.

3. The computer implemented method of claim 1 wherein determining the boundary constraints comprises:
determining a highest lower bound of the settlement price for the constituent contract based on the synthetic market data; and
determining a lowest upper bound of the settlement price for the constituent contract based on the synthetic market data.

4. The computer implemented method of claim 3 wherein computing the settlement price for the constituent contract comprises calculating an average of the highest lower bound and the lowest upper bound to compute the settlement price for the constituent contract.

5. The computer implemented method of claim 3 wherein, if the highest lower bound and the lowest upper bound cross, determining the boundary constraints comprises:
of the highest lower bound and the lowest upper bound, discarding the boundary constraint associated with a wider market based on the bid-offer data; and
performing an iteration of determining the highest lower bound and determining the lowest upper bound.

6. The computer implemented method of claim 5 wherein, if all of the boundary constraints are discarded, computing the settlement price for the constituent month contract further comprises calculating the settlement price for the constituent contract based on a metric other than the bid-offer values.

7. The computer implemented method of claim 6 wherein the metric comprises trade data associated with another contract.

8. The computer implemented method of claim 1, further comprising determining whether to use the market data indicative of the bid-offer values for the plurality of spread instruments or whether to use trade data indicative of trades involving the constituent contract or another contract.

9. The computer implemented method of claim 1 wherein the synthetic market data comprises synthetic bid-offer values for the constituent contract for each spread instrument of the plurality of spread instruments.

10. The computer implemented method of claim 1 wherein:
the active contract is a lead month contract; and
the constituent contract is a deferred month contract.

11. A system for determining a settlement price for a constituent contract of a plurality of spread instruments, the plurality of spread instruments having the constituent contract in common, the system comprising a processor and a memory coupled with the processor, the system further comprising:
first logic stored in the memory and executable by the processor to obtain market data indicative of bid-offer values for the plurality of spread instruments;
second logic stored in the memory and executable by the processor to generate synthetic market data for the constituent contract based on the bid-offer values and based on a respective settlement price for an active contract of each spread instrument of the plurality of spread instruments;
third logic stored in the memory and executable by the processor to determine boundary constraints on the settlement price for the constituent contract based on the synthetic market data; and
fourth logic stored in the memory and executable by the processor to compute the settlement price for the constituent contract based on the boundary constraints.

12. The system of claim 11 wherein the second logic is further executable by the processor to subtract the bid-offer values from the respective settlement price for the active contract.

13. The system of claim 11 wherein the third logic is further executable by the processor to:
determine a highest lower bound of the settlement price for the constituent contract based on the synthetic market data; and
determine a lowest upper bound of the settlement price for the constituent contract based on the synthetic market data.

14. The system of claim 13 wherein the fourth logic is further executable by the processor to calculate an average of the highest lower bound and the lowest upper bound to compute the settlement price for the constituent contract.

15. The system of claim 13 wherein, if the highest lower bound and the lowest upper bound cross, the third logic is further executable by the processor to:
of the highest lower bound and the lowest upper bound, discard the boundary constraint associated with a wider market based on the bid-offer data; and
perform an iteration of determining the highest lower bound and determining the lowest upper bound.

16. The system of claim 15 wherein, if all of the synthetic market data is discarded for one of the boundary constraints, the fourth logic is further executable by the processor to calculate the settlement price for the constituent contract based on a metric other than the bid-offer values.

17. The system of claim 16 wherein the metric comprises trade data associated with another contract.

18. The system of claim 11, further comprising fifth logic stored in the memory and executable by the processor to determine whether to determine the settlement price of the constituent contract based on the market data indicative of the bid-offer values for the plurality of spread instruments or based on trade data indicative of trades involving the constituent contract or another month contract.

19. The system of claim 11 wherein the synthetic market data comprises synthetic bid-offer values for the constituent contract for each spread instrument of the plurality of spread instruments.

20. A system for determining a settlement price for a constituent contract of a plurality of spread instruments, the plurality of spread instruments having the constituent contract in common, the system comprising:
means for obtaining market data indicative of bid-offer values for the plurality of spread instruments;
means for generating synthetic market data for the constituent contract based on the bid-offer values and based on a respective settlement price for an active contract of each spread instrument of the plurality of spread instruments;
means for determining boundary constraints on the settlement price for the constituent contract based on the synthetic market data; and
means for computing the settlement price for the constituent contract based on the boundary constraints.

21. The system of claim 20, wherein means for determining the boundary constraints comprises:
means for determining a highest lower bound of the settlement price for the constituent contract based on the synthetic market data; and
means for determining a lowest upper bound of the settlement price for the constituent contract based on the synthetic market data.
